(19) United States
(12) Patent Application Publication
(10) Pub. No.: US 2019/0236260 A1
(43) Pub. Date: Aug. 1, 2019

(54) ELECTRONIC APPARATUS, CONTROL SYSTEM, CONTROL METHOD, AND STORAGE MEDIUM

(71) Applicants: KABUSHIKI KAISHA TOSHIBA, Tokyo (JP); Toshiba Client Solutions CO., LTD., Tokyo (JP)

(72) Inventor: Rinzo Iwamoto, Nishitama Tokyo (JP)

(21) Appl. No.: 16/042,545

(22) Filed: Jul. 23, 2018

(30) Foreign Application Priority Data
Jan. 31, 2018 (JP) 2018-014660

(51) Int. Cl. G06F 21/36; G06K 7/14; G06K 7/10

(52) U.S. Cl. CPC G06F 21/36; G06K 7/10722; G06K 7/1413

(57) ABSTRACT

According to one embodiment, an electronic apparatus carried by a user includes a transceiver and a hardware processor. The transceiver establishes a wired connection or a wireless connection between the electronic apparatus and a wearable device that is worn by the user. While a barcode encoded with information is displayed on a screen of an external electronic device, the hardware processor acquires an image depicting the barcode using a camera provided in the wearable device, determines the information encoded in the barcode from the image of the barcode, and executes processing based on the information determined from the barcode.

### CROSS-REFERENCE TO RELATED APPLICATIONS

This application is based upon and claims the benefit of priority from Japanese Patent Application No. 2018-014660, filed Jan. 31, 2018, the entire contents of which are incorporated herein by reference.

### FIELD

Embodiments described herein relate generally to an electronic apparatus, a control system, a control method, and a storage medium.

### BACKGROUND

Recently, an IoT (Internet of Things) age in which many things are connected through the Internet has come. A technique called “edge computing” is required as a tool for network communication and information sharing in offices, factories, and in other various situations. In order to realize the edge computing, development of a practical mobile edge computing device (MECD) having high degrees of versatility and processing capacity and can be used by a worker (user) on site is needed separately from a data center (or cloud). Thereby, it is expected that promotion of the operational efficiency and productivity improvement at a workplace and the like, or load dispersion of data and improvement in a network environment and the like will be achieved.

Mobile devices such as MECD may be used with any wearable device such as an eyeglass-type equipment and a bracelet-type equipment. The mobile device and the wearable device mutually transmit and receive data, so that the mobile device can process data generated by, for example, a camera or a sensor provided in the wearable device.

On the other hand, in a case where a user carries a mobile device and wears various wearable devices such as the eyeglass-type equipment and the bracelet-type equipment, and performs a hands-free operation, it is assumed to connect an input device such as a mouse or a keyboard to the mobile device. However, letting the user operate such an input device constitutes an obstacle to the hands-free operation, so that such operation is not realistic. Therefore, it is necessary to provide a new function that can easily control the mobile device without hindering an operation.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram for describing a configuration of a control system including an electronic apparatus (mobile PC) according to a first embodiment.

FIG. 2 is a block diagram showing an example of a system configuration of a setting PC included in the control system in FIG. 1.

FIG. 3 is a perspective view showing an example of an external appearance of a wearable device included in the control system in FIG. 1.

FIG. 4 is a perspective view showing an example of an external appearance of a main body of the wearable device in FIG. 3.

FIG. 5 is a perspective view showing an example of connection between the electronic apparatus of the first embodiment and the main body of the wearable device in FIG. 4.

FIG. 6 is a block diagram showing an example of a system configuration of the wearable device in FIG. 3.

FIG. 7 is a view showing an example of an external appearance of a front face, a side face, and a top face of the electronic apparatus of the first embodiment.

FIG. 8 is a block diagram showing an example of a system configuration of the electronic apparatus of the first embodiment.

FIG. 9 is a diagram showing an example of a setting sequence executed in the control system in FIG. 1.

FIG. 10 is a block diagram showing a functional configuration of the setting PC in FIG. 2.

FIG. 11 is a diagram showing a configuration example of control information used by the electronic apparatus of the first embodiment and the setting PC in FIG. 2.

FIG. 12 is a block diagram showing a functional configuration of the electronic apparatus of the first embodiment.

FIG. 13 is a flowchart showing an example of a procedure of a barcode generation processing executed by the setting PC in FIG. 2.

FIG. 14 is a flowchart showing an example of a procedure of a barcode control processing executed by the electronic apparatus of the first embodiment.

FIG. 15 is a view showing an example of a wireless LAN access point setting screen displayed by the electronic apparatus of the first embodiment.

FIG. 16 is a diagram showing an example of an SSID input screen displayed by the electronic apparatus of the first embodiment.

FIG. 17 is a diagram showing an example of a password input screen displayed by the electronic apparatus of the first embodiment.

FIG. 18 is a diagram showing an example of a setting sequence executed in a control system including an electronic apparatus of the second embodiment.

FIG. 19 is a flowchart showing an example of a procedure of a barcode generation processing executed by the setting PC included in the control system in FIG. 18.

FIG. 20 is a flowchart showing an example of a procedure of a barcode control processing executed by the electronic apparatus of the second embodiment.

### DETAILED DESCRIPTION

Various embodiments will be described hereinafter with reference to the accompanying drawings.

Hereinafter, embodiments will be described with reference to the drawings. Note that the disclosure is merely an example, and the invention is not limited by the content described in the following embodiments. Naturally, the modifications easily conceivable by those skilled in the art are included in the scope of the disclosure. In order to make the description clearer, there are cases where the size, shape, etc., of each part in the drawings are schematically represented by changing them relative to the actual embodiment. In a plurality of drawings, corresponding elements are denoted by the same reference numerals, and a detailed explanation may be omitted.

In general, according to one embodiment, an electronic apparatus carried by a user includes a transceiver and a hardware processor. The transceiver establishes a wired connection or a wireless connection between the electronic apparatus and a wearable device that is worn by the user. While a barcode encoded with information is displayed on a screen of an external electronic device, the hardware processor acquires an image depicting the barcode using a camera provided in the wearable device, determines the information encoded in the barcode from the image of the barcode, and executes processing based on the information determined from the barcode.

### First Embodiment

[Control System]

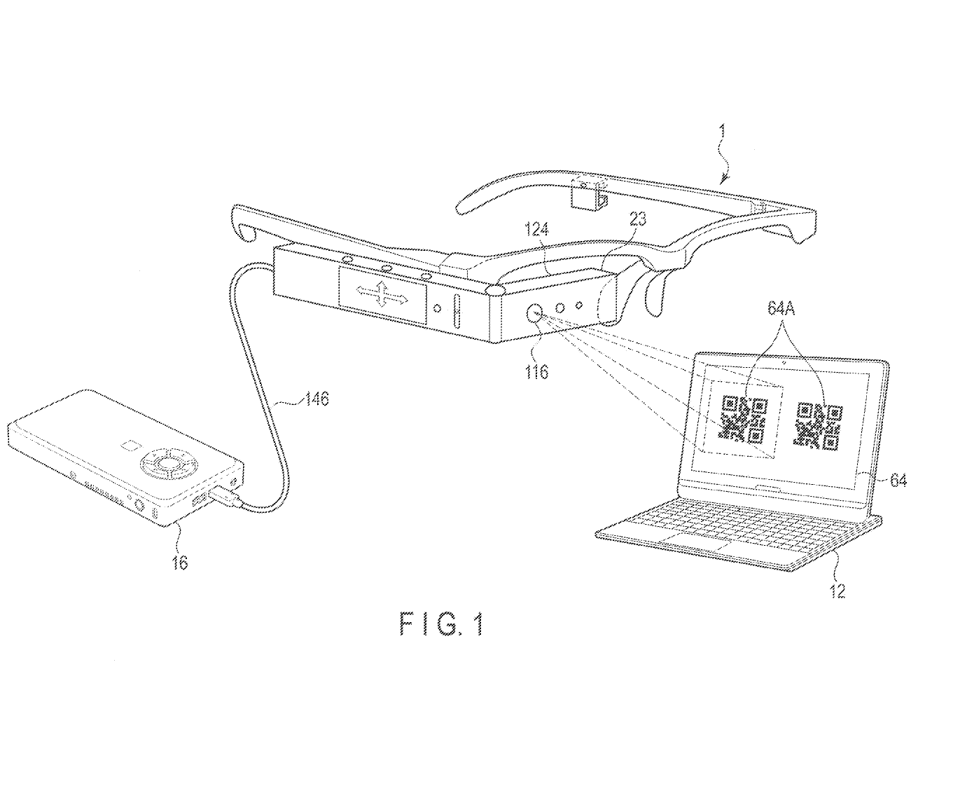

First, referring to FIG. 1, a configuration of a control system 1 including an electronic apparatus according to an embodiment will be described. This electronic apparatus is an electronic apparatus that can be carried by a user and can be implemented as a mobile personal computer (PC) including a mobile edge computing device (MECD), or a mobile information terminal such as a smartphone, a mobile phone, a PDA, and the like. Hereinafter, a case where this electronic apparatus is realized as a mobile PC 16 will be exemplified.

The control system 1 includes the mobile PC 16, a wearable device 23, and a setting PC 12. The user carries the mobile PC 16 and wears the wearable device 23. The wearable device 23 can be worn on a user's body (for example, the arm, the neck, the head, etc.). As the wearable device 23, a wearable device of a glass-type, a bracelet-type, a wristwatch-type, a headphone-type, or the like can be used. In the following, it is assumed that the wearable device 23 is a glass-type wearable device.

The mobile PC 16 and the wearable device 23 establish a wired connection or a wireless connection. In the example shown in FIG. 1, the mobile PC 16 and the wearable device 23 are connected by a cable 146. This cable 146 is, for example, a cable conforming to USB type-C (registered trademark) standard. The mobile PC 16 and the wearable device 23 may be connected by various wireless communication methods such as wireless LAN or Bluetooth (registered trademark).

The wearable device 23 includes a camera 116 and a display 124. The camera 116 can be configured to be able to perform capturing at any time during the period in which the wearable device 23 is in use. The wearable device 23 can transmit an image captured by the camera 116 to the mobile PC 16. In addition, the wearable device 23 can receive the image transmitted by the mobile PC 16 and display the image on the screen of the display 124. The wearable device 23 is a wearable viewer allowing a user who wears it to watch the image.

The setting PC 12 is an electronic apparatus including a display, and can be implemented as, for example, a notebook PC, a desktop PC, or an embedded system incorporated in various electronic apparatuses. The setting PC 12 may be implemented as a portable information terminal such as a tablet PC, a smartphone, a mobile phone, a PDA, or the like. FIG. 1 illustrates a case where the setting PC 12 is a notebook type PC.

The setting PC 12 displays, on the screen of a display (LCD) 64, a barcode 64A encoded with information for controlling the mobile PC 16. Each barcode 64A, for example, is encoded with various information such as one or more commands and text used for controlling the mobile PC 16. One barcode 64A may be displayed on the screen of the setting PC 12 or multiple barcodes 64A may be displayed on the screen of the setting PC 12 at the same time. The setting PC 12 may display the barcode 64A on a screen of an external display connected using an HDMI (registered trademark) connector or the like instead of the LCD 64.

As shown in FIG. 1, for example, the user directs the camera 116 of the attached wearable device 23 to the barcode 64A displayed on the screen of the setting PC 12 (external electronic apparatus) and captures the barcode 64A, so that an image (image data) of the barcode 64A is generated. Note that the wearable device 23 may not be worn by the user at this time. In this case, for example, the user holds the wearable device 23 and performs capturing by directing the camera 116 to the barcode 64A displayed on the screen of the setting PC 12. The wearable device 23 transmits the generated image to the mobile PC 16.

The mobile PC 16 receives the image transmitted from the wearable device 23 and analyzes the image, thereby acquiring the information with which the barcode 64A in the image is encoded. Then, the mobile PC 16 executes processing according to the acquired information (for example, command, text, etc.). That is, the mobile PC 16 executes a specific function assigned to the barcode 64A. Therefore, it is possible to cause the mobile PC 16 to execute any processing using the barcode 64A. Note that this processing may include not only processing for controlling the mobile PC 16 but also processing for controlling the wearable device 23 connected to the mobile PC 16.

With the above configuration, in the control system 1, in a case where the user carries the mobile PC 16 and is carrying out the hands-free operation or the like with the wearable device 23 mounted thereon, it is possible to easily control at least one of the mobile pc 16 and the wearable device 23 without performing an operation using an input device such as a mouse or a keyboard connected to the mobile PC 16.

Hereinafter, each of the above-described configurations will be described more specifically.

[Setting PC 12]

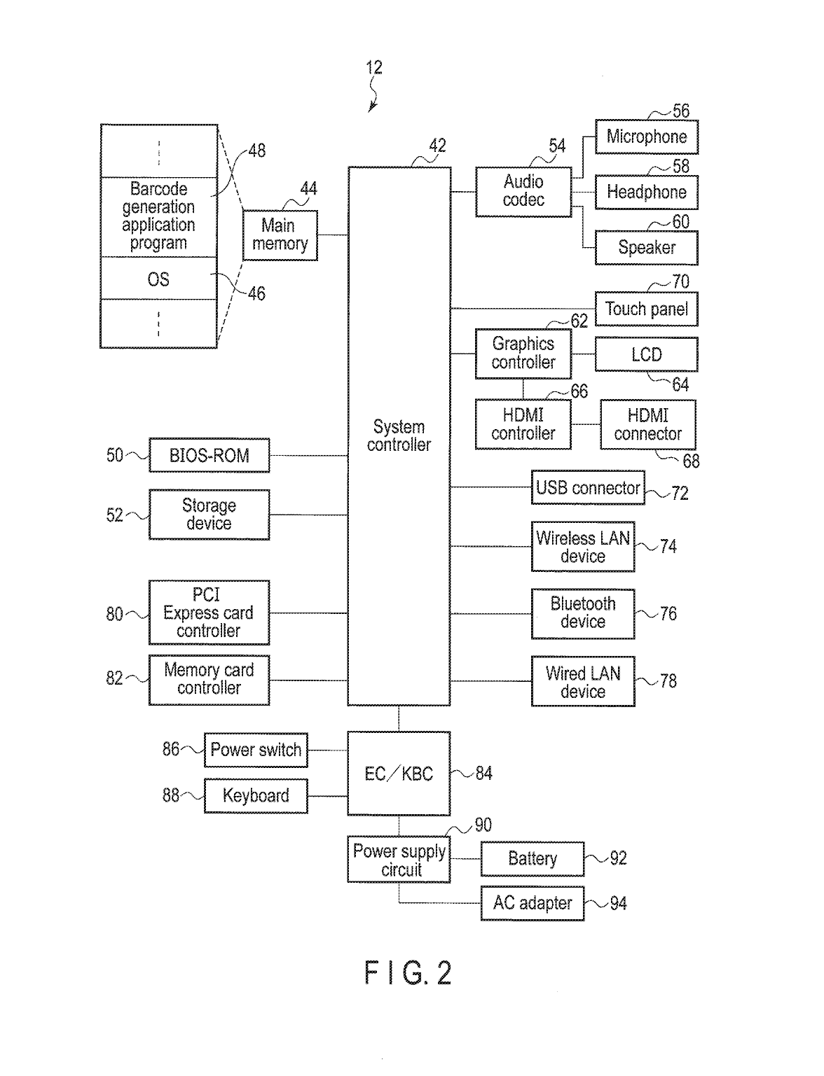

FIG. 2 shows a system configuration of the setting PC 12. The setting PC 12 includes a system controller 42 including a processor. A main memory 44, a BIOS-ROM 50, a storage device 52 including an HDD or an SSD, an audio codec 54, a graphics controller 62, a touch panel 70, a USB (registered trademark) connector 72, a wireless LAN device 74, a Bluetooth device 76, a wired LAN device 78, a PCI Express (registered trademark) card controller 80, a memory card controller 82, an embedded controller/keyboard controller (EC/KBC) 84, and the like are connected to the system controller 42.

The system controller 42 executes various programs loaded from the storage device 52 into the main memory 44. These programs include an operating system (OS) 46 and a barcode generation application program 48 for generating barcodes. The system controller 42 controls the operation of each component the setting PC 12 by executing instructions included in the barcode generation application program 48.

The system controller 42 also executes a basic input/output system (BIOS) stored in the BIOS-ROM 50 that is a nonvolatile memory. The BIOS is a system program for hardware control.

The audio codec 54 converts a digital audio signal to be reproduced into an analog audio signal and supplies the converted analog signal to a headphone 58 or a speaker 60. Further, the audio codec 54 converts an analog audio signal input thereto from a microphone 56 into a digital signal. Although the microphone 56 and the headphone 58 may be provided independently, they may be integrally provided as an intercom.

The graphics controller 62 controls a liquid crystal display (LCD) 64 used as a display monitor of the setting PC 12. The touch panel 70 is overlaid on the screen of the LCD 64 so that handwriting input operation with a touch pen or the like can be performed on the screen of the LCD 64. An HDMI controller 66 is also connected to the graphics controller 62. The HTMI controller 66 is connected to an HDMI connector 68 for connection with an external display device.

The wireless LAN device 74 executes wireless LAN communication conforming to the IEEE 802.11 standard for connection with a network. The Bluetooth device 76 executes wireless communication conforming to the Bluetooth standard for connection with external apparatus. The wired LAN device 78 executes the wired LAN communication conforming to the IEEE 802.3 standard for connection with the network. In this manner, connection between the setting PC 12 and the network may be made by wireless communication or may be made by wired communication.

A PCI Express card controller 80 performs communication conforming to the PCI Express standard between the setting PC 12 and the external device. The memory card controller 82 writes data to a storage medium, for example, a memory card such as an SD (secure digital) card (registered trademark), and reads the data from the memory card.

An EC/KBC 84 is a power management controller and is implemented as a one-chip microcomputer incorporating a keyboard controller for controlling a keyboard 88. The EC/KBC 84 has a function of powering on or powering off the setting PC 12 according to the operation of a power switch 86. The control of power on and power off is executed by cooperative operation of the EC/KBC 84 and a power supply circuit 90. The EC/KBC 84 is operated by electric power from a battery 92 or an AC adapter 94 even when the setting PC 12 is powered off. The power supply circuit 90 generates electric power to be supplied to each component using electric power from the battery 92 or electric power from the AC adapter 94 connected as an external power supply.

[Wearable Device 23]

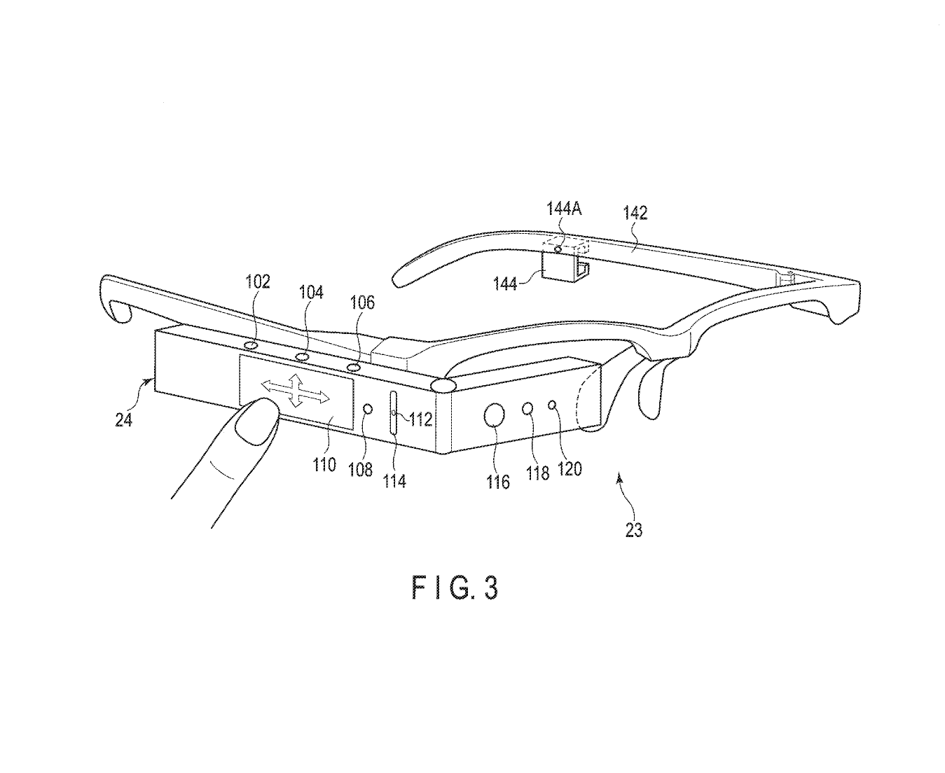

FIG. 3 shows an example of the external appearance of the wearable device 23 connected to the mobile PC 16. The wearable device 23 includes an eyeglass frame 142 and a wearable device main body 24. The eyeglass frame 142 may have a shape obtained by removing a lens from general eyeglasses, and is mounted on the face of an operator. The eyeglass frame 142 may have a structure to which eyeglasses are attached. In a case where an operator regularly uses eyeglasses, lenses having the same power as those of regularly used eyeglasses may be attached to the eyeglass frame 142.

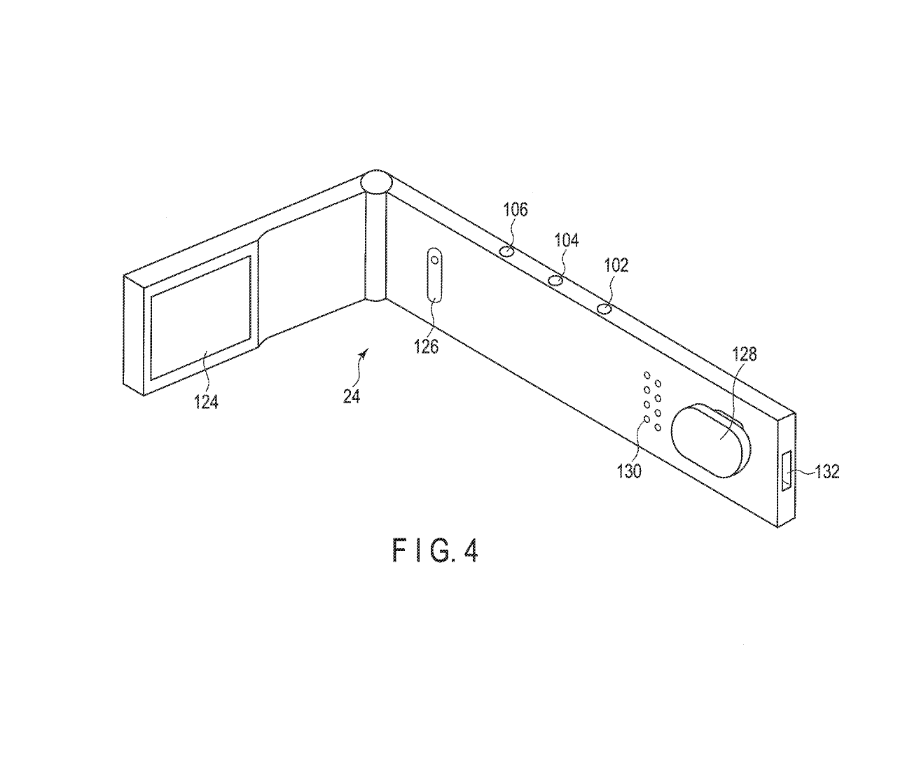

The eyeglass frame 142 is provided with mounting brackets 144 on both the right and left temples thereof. The wearable device main body 24 is attached to and detached from one of the mounting brackets 144 on the right or left temple. In FIG. 3, the mounting bracket 144 on the temple on the right side of the worker is hidden behind the wearable device main body 24, and hence is not shown. As described above, the wearable device main body 24 is provided with a display device 124 (shown in FIG. 4). The display device 124 is configured in such a way as to be viewed by one eye. Therefore, the mounting brackets 144 are provided on both the right and left temples so that the wearable device main body 24 can be attached to the mounting bracket on the dominant eye side. The wearable device main body 24 need not be detachably attached to the eyeglass frame 142 by means of the mounting bracket 144. The wearable devices 23 for the right eye and left eye in which the wearable device main bodies 24 are respectively fixed to the eyeglass frames 142 on the right and left frames may be prepared. Furthermore, the wearable device main body 24 may not be attached to the eyeglass frame 142, but may be attached to the head of the worker by using a helmet or goggle.

An engaging piece 128 (shown in FIG. 4) of the wearable device main body 24 is forced between upper and lower frames of the mounting bracket 144, whereby the wearable device main body 24 is attached to the eyeglass frame 142. When the wearable device main body 24 is to be detached from the eyeglass frame 142, the wearable device main body 24 is plucked out of the mounting bracket 144.

In a state where the wearable device main body 24 is attached to the mounting bracket 144, the engaging piece 128 is somewhat movable backward and forward in the mounting bracket 144. Accordingly, the wearable device main body 24 is adjustable in the front-back direction so that the worker's eve can be brought to a focus on the display device 124. Furthermore, the mounting bracket 144 is rotatable around an axis 144A perpendicular to the temple. After the wearable device main body 24 is attached to the eyeglass frame 142, the wearable device main body 24 is adjustable in the vertical direction so that the display device 124 can be positioned on the worker's line of sight. Moreover, the rotational angle of the mounting bracket 144 is about 90 degrees and, by largely rotating the mounting bracket 144 in the upward direction, the wearable device main body 24 can be flipped up from the eyeglass frame 142. Thereby, even when it is difficult to watch the real thing because the field of view is obstructed by the wearable device main body 24 or even when the wearable device main body 24 interferes with surrounding objects in a small space, it is possible to temporarily divert/restore the wearable device main body 24 from/to the field of view of the worker without detaching/reattaching the entire wearable device 23 from/to the face of the worker.

[Wearable Device Main Body 24]

The wearable device main body 24 is constituted of a side part to be along the temple of the eyeglass frame 142, and front part to be positioned on the line of sight of one eyeball of the worker. The angle which the front part forms with the side part is adjustable.

As shown in FIG. 3, on the outside surface of the front part, a camera 116, a light 118, and a camera LED 120 are provided. The light 118 is an auxiliary lighting fixture emitting light at the time of shooting a dark object. The camera LED 120 is configured to be turned on at the time of shooting a photograph or video to thereby cause the objective person to be photographed to recognize that he or she is to be photographed.

On the top surface of the side part of the wearable device main body 24 attached to the right side temple, first, second, and third buttons 102, 104, and 106 are provided. When the dominant eye of the worker is the left eye, the wearable device main body 24 is attached to the left side temple. The top and the bottom of the wearable device main body 24 are reversed according to whether the wearable main body 24 is attached to the right side temple or to the left side temple. Therefore, the first, second, and third buttons 102, 104, and 106 may be provided on both the top surface and undersurface or the side part.

On the outside surface of the side part, a touch pad 110, fourth button 103, microphone 112, and illuminance sensor 114 are provided. The touch pad 110 and fourth button 108 can be operated by a forefinger. When the wearable device main body 24 is attached to the right side temple, the buttons 102, 104, and 106 are arranged at positions at which the buttons 102, 104, and 106 can be operated by a forefinger, middle finger, and third finger, respectively. The touch pad 110 is configured such that the movement of finger in up and down directions or back and forth directions on the surface on the touch pad 110 as indicated by arrows can be detected. The movement to be detected includes flicking of a finger for grazing the surface quickly in addition to dragging of a finger for moving the finger with the finger kept in contact with the surface. Upon detection of up-and-down or back-and-force movement of the worker's finger, the touch pad 110 inputs a command. In this description, a command implies an executive instruction to execute specific processing to be issued to the wearable device main body 24. Operation procedures for the first to fourth buttons 102, 104, 106, and 108, and touch pad 110 are determined in advance by the application program.

For example,
when the third button 106 is pressed once, item selection/item execution is carried out,
when the third button 106 is pressed for a long time, a list of activated application programs is displayed,
when the second button 104 is pressed once, the screen returns to the home screen,
when the second button 104 is pressed for a long time, a menu of quick settings is displayed, and
when the first button 102 is pressed once, cancellation (operation identical to the operation of the Esc key of the keyboard) of an operation is executed.

Regarding the operation of the touch pad 110, for example,
when the touch pad 110 is dragged up and down, the cursor is moved up and down,
when the touch pad 110 is flicked forward (to the front of the head), the left icon is selected (continuously scrolled),
when the touch pad 110 is flicked backward (to the back of the head), the right icon is selected (continuously scrolled),
when the touch pad 110 is dragged forward, the left icon is selected (items are scrolled one by one), and
when the touch pad 110 is dragged backward, the right icon is selected (items are scrolled one by one).

The first button 102 is arranged at such a position as to be operated by a forefinger, second button 104 at a position by a middle finger, third button 106 at a position by a third finger, and fourth button 108 at a position by a little finger. The reason why the fourth button 108 is provided not on the top surface of the side part, but on the outside surface of the side part in FIG. 3 is that there is space restriction. The fourth button 108 may also be provided on the top surface of the side part in the same manner as the first to third buttons 102, 104, and 106. The illuminance sensor 114 detects the illuminance of the surrounding area in order to automatically adjust the brightness of the display device.

FIG. 4 shows an example of an external appearance or the back side of the wearable device main body 24. On the inner side of the front part, a display device 124 constituted of an LCD is provided. On the inner side of the side part, a microphone 126, speaker 130, and engaging piece 128 are provided. The microphone 126 is provided at a front position of the side part, and speaker 130 and engaging piece 128 at a rear position of the side part. Headphones may be used in place of the speaker 130. In this case, the microphone and headphones may also be provided in an integrated manner as an intercom in the same manner as the setting PC 12.

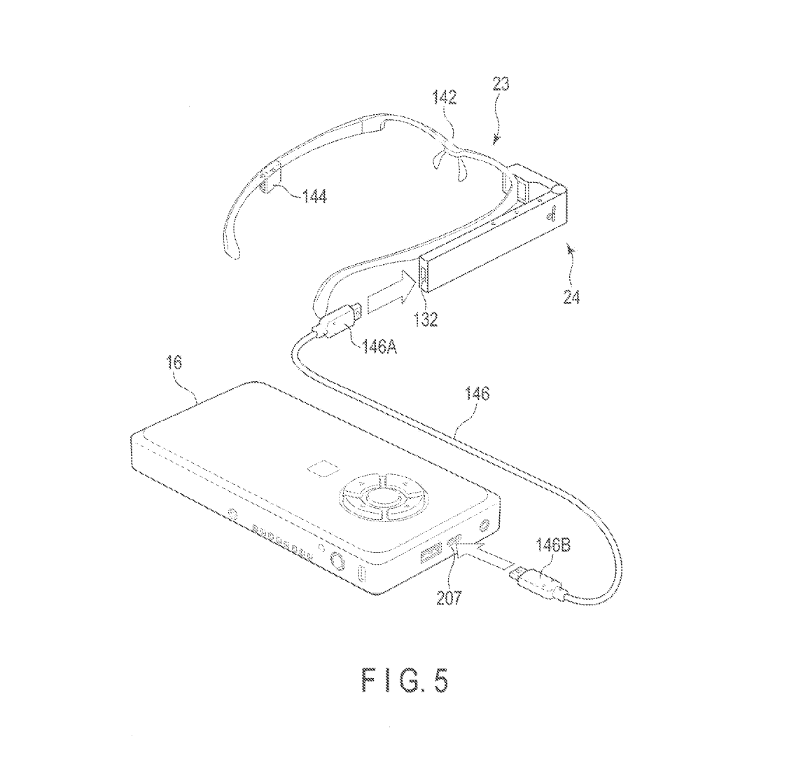

FIG. 5 shows an example of connection between the mobile PC 16 and wearable device main body 24. At a rear position of the side part, a receptacle 132 into which a plug 146A at one end of a cable 146 conforming to the USB type-C (registered trade mark) standard is to be inserted is provided. A plug 146B at the other end of the USB type-C cable 146 is inserted into a connector 207 conforming to the USB type-C standard provided on an upper end face of the mobile PC 16. As described above, the wearable device main body 24 is connected to the mobile PC 16 through the USB type-C cable 146, and image signals and the like are transmitted from/to the wearable device main body 24 to/from the mobile PC 16 through the USB type-C cable 146. The wearable device main body 24 may also be connected to the mobile PC 16 by means of wireless communication such as a wireless LAN, Bluetooth, and the like.

In the embodiment, the wearable device main body 24 is not provided with a battery or DC terminal serving as a drive power supply, and the drive power is supplied from the mobile PC 16 to the wearable device main body 24 through the USE type-C cable 146. However, the wearable device main body 24 may also be provided with a drive power supply.

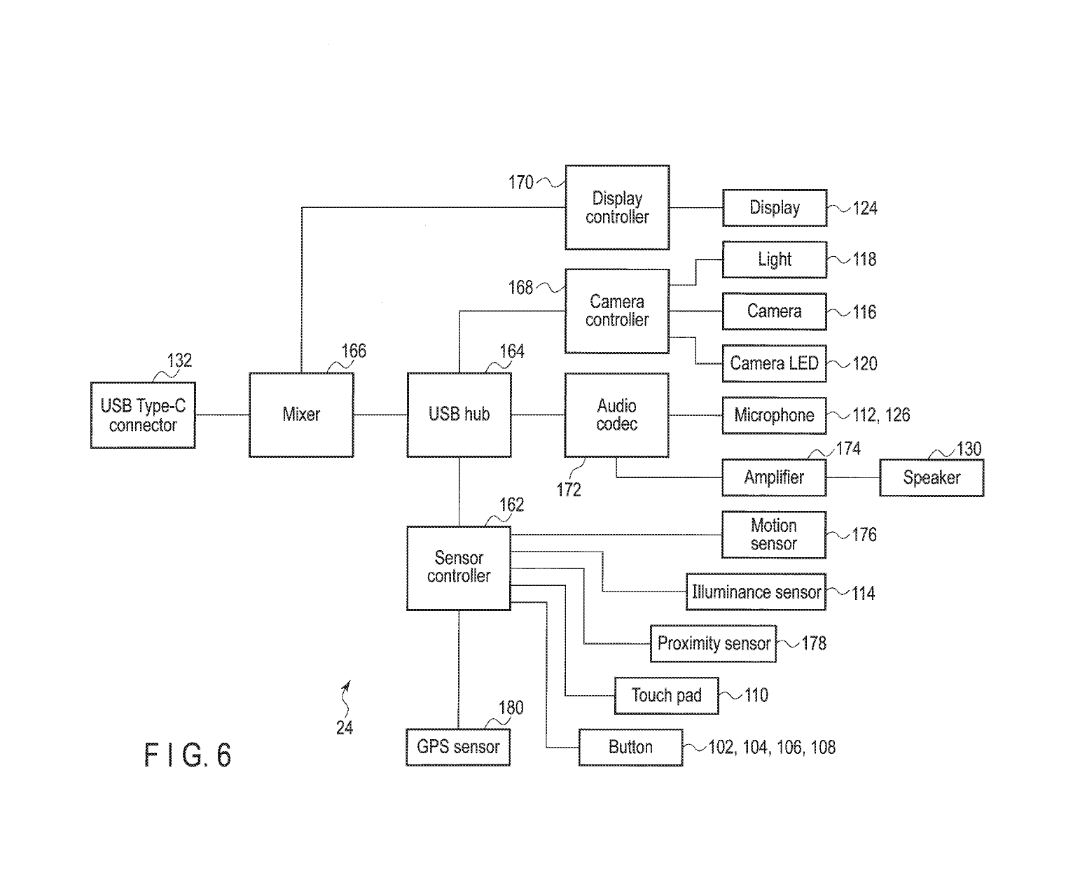

FIG. 6 is a block diagram showing an exemplary structure of the wearable device main body 24. The USE type-C connector 132 is connected to a mixer 166. A display controller 170 and USE hub 164 are respectively connected to a first terminal, and second terminal of the mixer 166. The display device 124 is connected to the display controller 170. A camera controller 168, audio codec 172, and sensor controller 162 are connected to the USB hub 164. The camera 116, light 118, and camera LED 120 are connected to the camera controller 168. Audio signals from the microphones 112 and 126 are input to the audio codec 172, and audio signal from the audio codec 172 is input to the speaker 130 through an amplifier 174.

A motion sensor (for example, acceleration, geomagnetism, gravitation, gyroscopic sensor, etc.) 176, the illuminance sensor 114, a proximity sensor 178, the touch pad 110, the first to fourth buttons 102, 104, 106, and 108, and a GPS sensor 180 are connected to the sensor controller 162. The sensor controller 162 processes detection signals from the motion sensor 176, illuminance sensor 114, proximity sensor 178, touch pad 110, first to fourth buttons 102, 104, 106, and 108, and GPS sensor 180, and supplies a command to the mobile PC 16. Although not shown in FIG. 4, the motion sensor 176, and proximity sensor 178 are arranged inside the wearable device main body 24. The motion sensor 176 detects a motion, direction, attitude, and the like of the wearable device main body 24. The proximity sensor 178 detects attachment of the wearable device 23 on the basis of approach of a face, finger and the like of the worker thereto.

[Mobile PC 16]

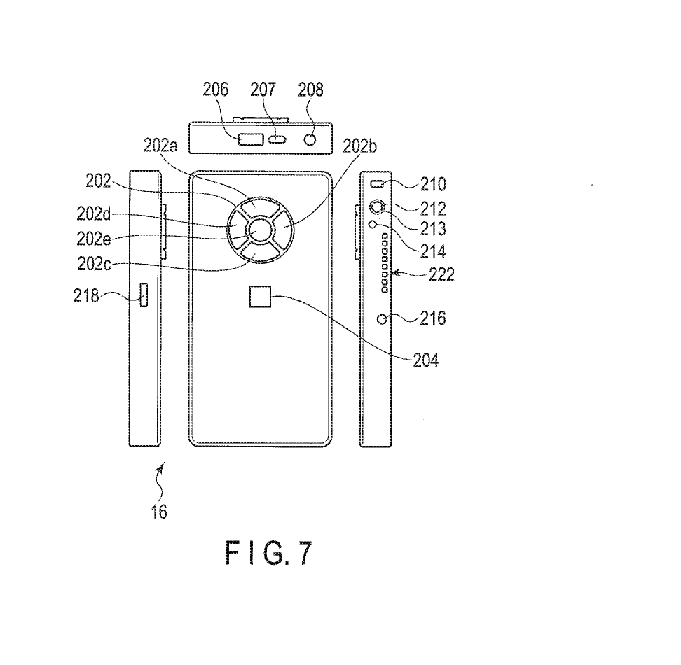

FIG. 7 shows an example of an external appearance of the mobile PC (mobile edge computing device) 16. The mobile PC 16 is a small-sized PC that can be held by one hand, and has a small size and light weight, i.e., a width thereof is about 10 cm or less, height thereof is about 18 cm or less, thickness thereof is about 2 cm, and weight thereof is about 300 g. Accordingly, the mobile PC 16 can be held in a pocket of the work clothing of the worker, holster to be attached to a belt, or a shoulder case, and is wearable. Although the mobile PC 16 incorporates therein semiconductor chips such as the CPU, semiconductor memory, and the like, and storage devices such as a Solid State Disk (SSD), and the like, the mobile PC 16 is not provided with a display device and hardware keyboard for input of characters.

On the front surface of the mobile PC 16, five buttons 202 constituted of an up button 202a, right button 202b, down button 202c, left button 202d, and decision button 202e (also called a center button or enter button) are arranged, and fingerprint sensor 204 is as below the five buttons 202. The mobile PC 16 is not provided with a hardware keyboard for input of characters, and a password number (also called a PIN) cannot be input. Therefore, the fingerprint sensor 204 is used for user authentication at the time of login of the mobile PC 16. A command can be input from the five buttons 202.

User authentication at the time of login may be carried out by allocating numeric characters to the buttons 202a to 202d of the five buttons 202, and inputting a password number by using the five buttons 202. In this case, the fingerprint sensor 204 can be omitted. Numeric characters are allocated to the four buttons other than the decision button 202e, and the number of the numeric characters is only four. Thus, there is a possibility of numeric characters input in a random manner being coincident with the password number. However, by making the digit number of the password number large, it is possible to make the probability that the numeric characters input in a random manner will be coincident with the password number low. Authentication by the five buttons 202 may be enabled in also a mobile PC 16 provided with a fingerprint sensor 204. Although one mobile PC 16 may be shared among a plurality of workers, it is not possible to cope with such a case by only the fingerprint authentication.

The operations identical to those of the buttons 102, 104, 106, and 108, and touch pad 110 of the wearable device main body 24 can also be applied to the five buttons 202. The worker cannot watch the state where the buttons 102, 104, 106, and 108, and touch pad 110 of the wearable device main body 24 are being operated. Therefore, it may be necessary for a worker to become accustomed to carrying out an intended operation depending on the worker. Further, the buttons 102, 104, 106, and 108, and touch pad 110 are small in size, and thus they may be difficult to operate. In the embodiment, the five buttons 202 of the mobile PC 16 can also be operated in the same manner as above, and hence the above-mentioned fear can be dispelled. The operation procedures of the five buttons 202 are determined by the application program.

For example,
when the decision button 202e is pressed once, item selection/item execution is carried out (corresponding to pressing once of the third button 106 in the wearable device main body 24),
when the decision button 202e is pressed for a long time, ending or cancellation of an operation is carried out (corresponding to pressing once of the first button 102 in the wearable device main body 24),
when the up button 202a is pressed once, the cursor is moved upward (corresponding to upward drag on the touch pad 110 in the wearable device main body 24),
when the up button 202a is pressed for a long time, a list of activated application programs is displayed (corresponding to pressing the third button 106 for a long time in the wearable device main body 24),
when the down button 202c is pressed once, the curs or is moved downward (corresponding to downward drag on the touch pad 110 in the wearable device main body 24),
when the down button 202c is pressed for a long time, a menu of quick settings is displayed (corresponding to pressing of the second button 104 for a long time in the wearable device main body 24),
when the left button 202d. is pressed once, the right icon is selected (corresponding to backward drag/flick on the touch pad 110 in the wearable device main body 24), and
when the right button 202b is pressed once, the left icon is selected (corresponding to forward drag/flick on the touch pad 110 in the wearable device main body 24).

On the upper side face of the mobile PC 16, a USB 3.0 connector 206, a USB type-C connector 207, and an audio jack 208 are provided.

On one side face (side face on the left side when viewed from the front) of the mobile PC 16, a memory card slot 218 for a memory card is provided. The memory card includes, for example, an SD card, micro SD card (registered trade mark), and the like.

On the other side face (side face on the right side when viewed from the front) of the mobile PC 16, a slot 210 for Kensington Lock (registered trade mark), power switch 212, power LED 213, DC IN/battery LED 214, DC terminal 216, and ventilation holes 222 for cooling are provided. The power LED 213 is arranged around the power switch 212, and turned on during the period of power-on. The DC IN/battery LED 214 indicates the state of the mobile PC 16 such as whether or not the battery is being charged, and remaining battery level. Although the mobile PC 16 can be driven by the battery, the mobile PC 16 can also be driven in the state where the AC adaptor is connected to the DC terminal 216. Although not shown, the back side of the mobile PC 16 is configured such that the battery can be replaced with a new one by a one-touch operation.

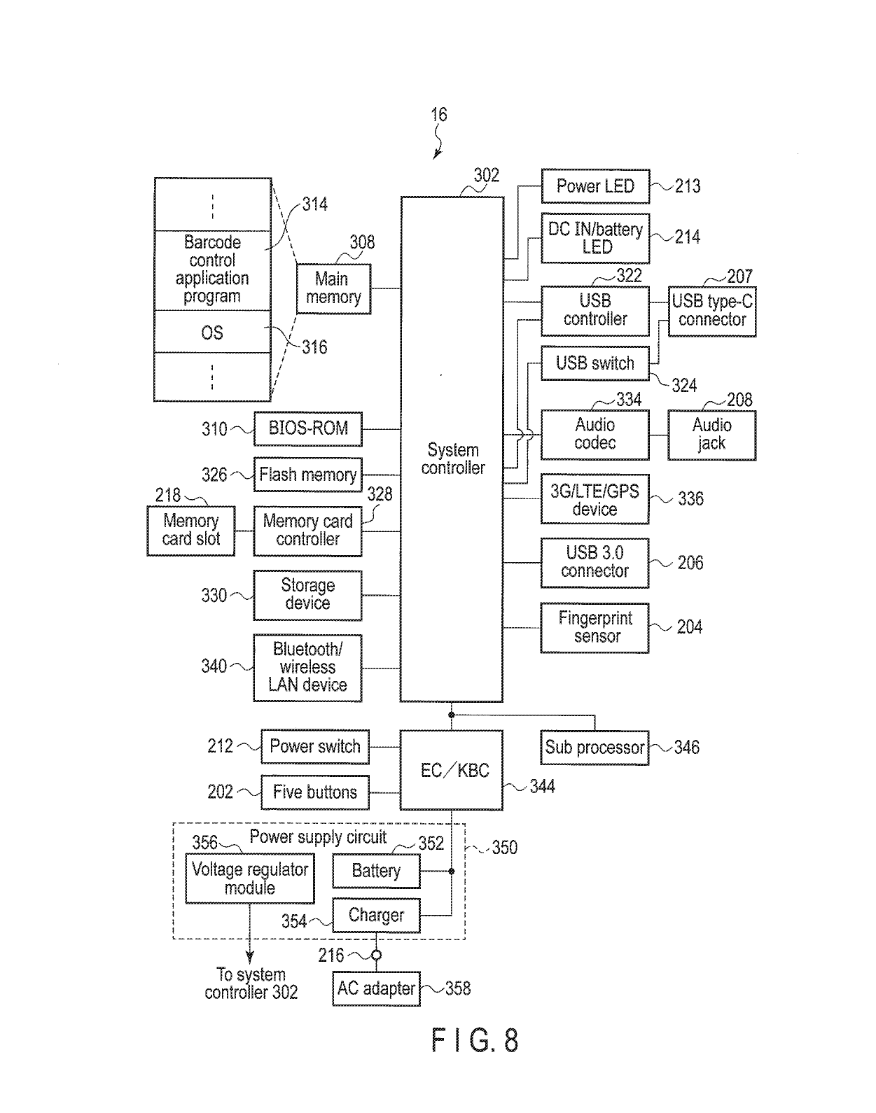

FIG. 8 shows an example of the system configuration of the mobile PC 16. The mobile PC 16 has, for example, a camera function and a viewer function. The camera function is a function of shooting photographs and videos with the camera 116 of the wearable device main body 24. The photographs and videos which have been taken are saved in the camera folder and can be viewed with the viewer function. The viewer function is a function of browsing the file saved in the camera folder. Types of files include images, moving images, PDF files, photos and videos taken with the camera function, and files saved in the user folder.

The mobile PC 16 includes a system controller 302, and the system controller 302 includes a processor (CPU) and a controller hub. A main memory 308, a BIOS-ROM 310, the power LED 213, the DC IN/battery LED 214, and a USE controller 322 are connected to the processor. A Flash memory 326, a memory card controller 328, a storage device 330 including an HDD or an SSD, a USB switch 324, an audio codec 334, a 3G/LTE/GPS device 336, the fingerprint sensor 204, a USB 3.0 connector 206, a Bluetooth device/wireless LAN device 340, and an EC/KBC 344 are connected to the controller hub.

The system controller 302 executes various programs loaded from the storage device 330 into the main memory 308. These programs include an OS 316 and a barcode control application program 314 for control based on a barcode. The system controller 302 controls the operation of each component in the mobile PC 16 by executing the instructions included in the barcode control application program 314.

The audio codec 334 converts a digital audio signal to be reproduced into an analog audio signal and supplies the converted analog signal to the audio jack 208. Further, the audio codec 334 converts an analog audio signal input from the audio jack 208 into a digital signal.

The memory card controller 328 accesses a memory card inserted into the memory card slot 218, for example, an SD card, and controls reading/writing of data from/to the SD card.

The USB controller 322 controls transmission and reception of data with respect to a USB type-C cable connected to the USB type-C connector 207 or a USB 3.0 cable (not shown) connected to the USB 3.0 connector 206.

Although not shown, a port extension adaptor including ports or connectors according to several interfaces can be connected also to the USB type-C connector 207, and an interface which is not provided in the mobile PC 16, such as the HDMI or the like, can be used.

The Bluetooth/wireless LAN device 340 executes wireless communication conforming to the Bluetooth/IEEE802.11 standard for the purpose of connection to the network. The connection to the network may not depend on wireless communication, and may depend on wired LAN communication conforming to the IEEE802.3 standard.

The fingerprint sensor 204 is used for fingerprint authentication at the time of startup of the mobile PC 16.

A sub-processor 346, the power switch 212, and the five buttons 202 are connected to the EC/KBC 344. The EC/KBC 344 has a function of turning on or turning off the power to the mobile PC 16 according to the operation of the power switch 212. The control of power-on and power-off is executed by the cooperative operation of the EC/KBC 344 and power circuit 350. Even during a power-off period of the mobile PC 16, the EC/KBC 344 operates by the power from a battery 352 or AC adaptor 358 connected as an external power supply. The power circuit 350 uses the power from the battery 352 or AC adaptor 358 to thereby generate power to be supplied to each component. The power circuit 350 includes a voltage regulator module 356. The voltage regulator module 356 is connected to the processor in the system controller 302.

Although the mobile PC 16 is constituted as a body separate from the wearable device main body 24, the mobile PC 16 may be incorporated into the wearable device main body 24, and both of them may also be integrated into one body.

[Control Sequence]

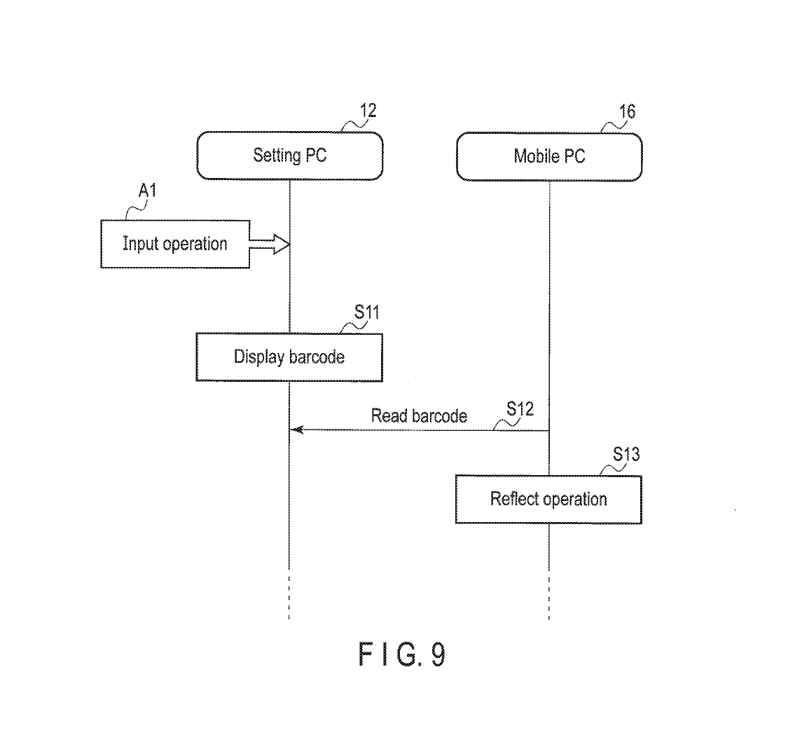

FIG. 9 shows an example of a control sequence executed in the control system 1.

First, in response to an artificial operation input A1 performed by a user, the setting PC 12 displays a barcode 64A on the screen, based on input information by the operation input A1 (S11). In the operation input A1, the user inputs input information for controlling the mobile PC 16 using various input devices for inputting operations by the user.

Next, the mobile PC 16 reads the barcode 64A displayed on the screen of the setting PC 12 using the camera 116 of the wearable device 23 (S12). For example, the mobile PC 16 reads one barcode 64A captured using the camera 116. Note that the mobile PC 16 may read multiple barcodes 64A which are captured at the same time using the camera 116. In reading the barcode 64A, the mobile PC 16 interprets the barcode 64A to acquire the input information with which the barcode 64A is encoded.

Then, the mobile PC 16 reflects the operation corresponding to the read barcode 64A (S13). That is, the mobile PC 16 executes the processing corresponding to the input information with which the barcode 64A is encoded.

As a result, the operation input A1 on the setting PC 12 can be reflected as an operation input on the mobile PC 16.

[Functional Configuration of Setting PC 12]

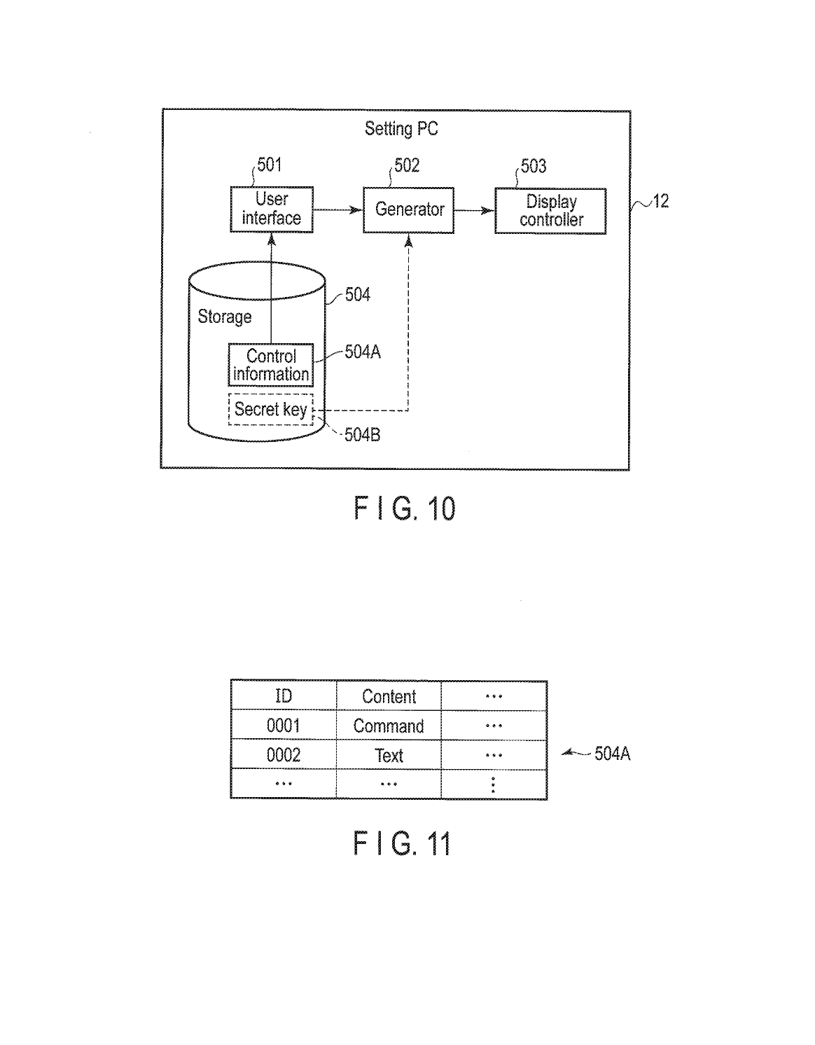

FIG. 10 shows an example of a functional configuration of the setting PC 12. The setting PC 12 includes, for example, a user interface 501, a generator 502, a display controller 503, and a storage 504. These modules 501, 502, 503, and 504 are realized by the system controller 42 (processor) of the setting PC 12 executing instructions included in the barcode generation application program 48 and controlling the operation of each component shown as the system configuration of the setting PC 12. The system configuration of the setting PC 12 is described above with reference to FIG. 2.

In a case where the user performs an operation using various input devices, the user interface 501 receives an input according to the operation. The user inputs information for controlling the mobile PC 16 using various input devices such as the keyboard 88 and the touch panel 70. More specifically, the user may input the type of information to be input to the mobile PC 16, the command to be executed by the mobile PC 16, the text to be input to the mobile PC 16, and the like. The user interface 501 generates input information indicative of the content of the received input. The input information includes at least one of a command executed by the mobile PC 16 and a text input to the mobile PC 16. In addition, the input information may further include information indicative of the type of information to be input to the mobile PC 16.

More specifically, a control information 504A stored in the storage 504 is used to generate the input information. The control information 504A is shared by the setting PC 12 and the mobile PC 16, and defines information for identifying the type of information to be input to the mobile PC 16.

FIG. 11 shows a configuration example of the control information 504A. The control information 504A includes records corresponding to input types. Each record includes “ID” and “content”. In a record corresponding to an input type, “ID” indicates identification information (first information) assigned to the input type. In the record, “content” indicates the content (second information) of the input type.

In FIG. 11, an example is shown in which the “content” of the input type whose “ID” is “0001” is a “command” and the “content” of the input type whose ID is “0002” is a “text”.

In a case where such control information 504A is used, some examples of the input information generated by the user interface 501 are shown below.

(1) In a case where the user performs an operation to input a command as information for controlling the mobile PC 16, the user interface 501 generates input information including first information indicating “0001” which is an ID corresponding to the command and second information which is the command input by the user.

(2) In a case where the user per an operation to input a text as information for controlling the mobile PC 16, the user interface 501 generates input information including first information indicating “0002” which is an ID corresponding to the text and second information which is the text input by the user.

The generator 502 generates the barcode 64A encoded with the input information, based on a specific rule for generating/interpreting the barcode. Each barcode 64A is an image code generated in accordance with the specific rule, and includes, for example, a one-dimensional barcode, a two-dimensional barcode, a hologram, and the like. The two-dimensional barcode is, for example, QR code (registered trademark). The barcode 64A may be any type of image code as long as the barcode 64A can be encoded with information for controlling the mobile PC 16.

The display controller 503 displays the barcode 64A on the screen of the LCD 64. The display controller 503 may display one barcode 64A or may display multiple barcodes 64A at the same time. In a case where displaying the multiple barcodes 64A, the display controller 503 displays the barcodes 64A in a specific arrangement according to the order in which the barcodes are desired to be input to the mobile PC 16 (order in which they are desired to be read).

[Functional Configuration of Mobile PC 16]

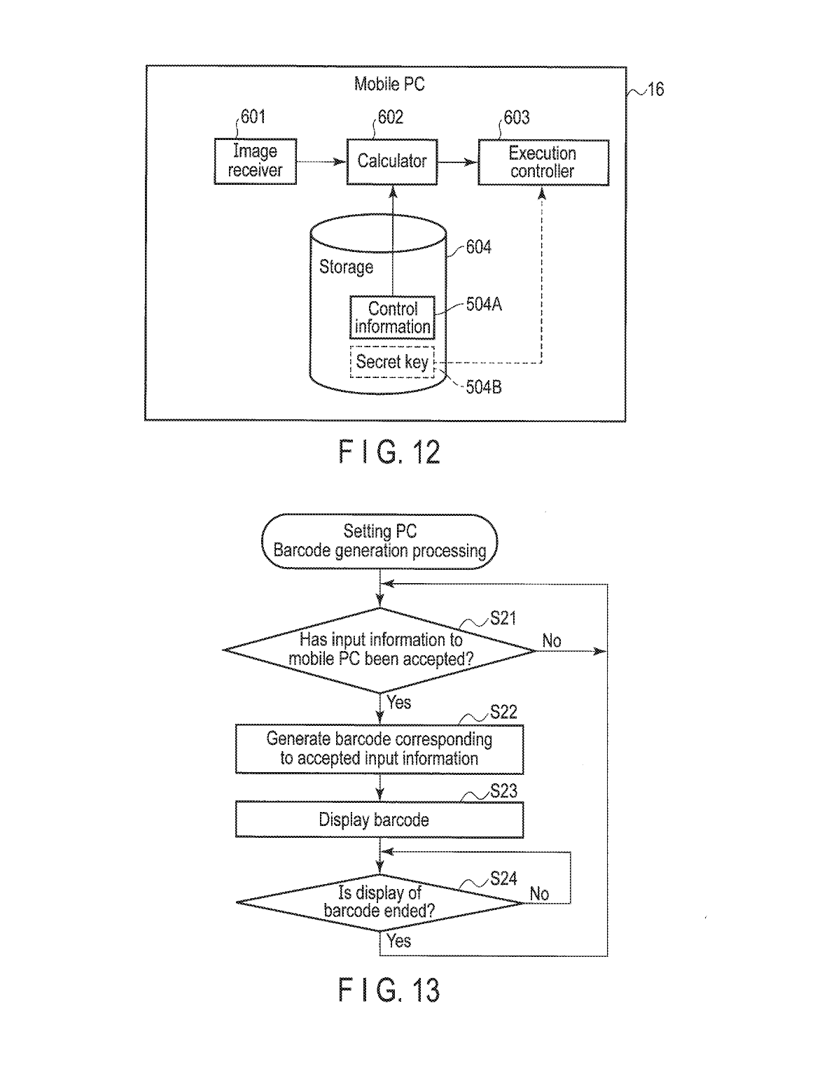

FIG. 12 shows an example of a functional configuration of the mobile PC 16. The mobile PC 16 includes, for example, an image receiver 601, a calculator 602, an execution controller 603, and a storage 604. These modules 601, 602, 603, and 604 are realized by the system controller 302 (processor) of the mobile PC 16 executing instructions included in the barcode control application program 314 and controlling the operation of each component shown as the system configuration of the mobile PC 16. The system configuration of the mobile PC 16 is described above with reference to FIG. 8. In the following description, it is assumed that one barcode 64A is displayed on the screen of the setting PC 12 for easy understanding.

The image receiver 601 acquires an image in which the barcode 64A is captured with the camera 116 provided in the wearable device 23 wiredly or wirelessly connected to the mobile PC 16. By sending and receiving data via the cable 146 connecting the mobile PC 16 and the wearable device 23, the image receiver 601 can request the wearable device 23 to acquire (photograph) an image with the camera 116, and can receive the acquired image. In a case where the camera 116 is configured to always shoot images while using the wearable device 23 (for example, in a case where the camera 116 is configured to sequentially generate images photographed at a predetermined frame rate), the image receiver 601 may receive generated images and acquire an image in which the barcodes 64A is captured from the images.

The calculator 602 calculates input information with which the barcode 64A is encoded from an image in which the barcodes 64A is captured. The calculator 602 calculates the input information by interpreting (decoding) the barcode 64A, based on a specific rule for generating/interpreting the barcode.

The execution controller 603 causes the mobile PC 16 to execute processing according to the calculated input information. The execution controller 603 specifies processing corresponding to the input information, for example, using the control information 504A stored in the storage 604. The configuration of the control information 504A is described above with reference to FIG. 11.

In a case where such control information 504A is used, some examples of processing executed by the execution controller 603 are described below.

(1) In a case where the first information indicating “0001” is included in the input information, the execution controller 603 interprets that the second information included in the input information is a command and causes the mobile PC 16 to execute processing according to the command.

(2) In a case where the first information indicating “0002” is included in the input information, the execution controller 603 interprets that the second information included in the input information is a text and causes the mobile PC 16 to execute processing according to the text.

[Barcode Generation Processing by Setting PC 12]

An example of the procedure of the barcode generation processing executed by the setting PC 12 will be described with reference to the flowchart in FIG. 13.

First, the setting PC 12 determines whether input information to the mobile PC 16 has been accepted (step S21). The setting PC 12 can receive information for controlling the mobile PC 16, wherein the information is input using the keyboard 88, the touch panel 70, or the like. In a case where the setting PC 12 has not accepted the input information to the mobile PC 16 yet (No in step S21), the processing returns to step S21 and again it is determined whether input information to the mobile PC 16 has been accepted.

In a case where the setting PC 12 has accepted the input information to the mobile PC 16 (Yes in step S21), the setting PC 12 generates the barcode 64A corresponding to the accepted input information (step S22). The generated barcode 64A is a barcode encoded with input information. Then, the setting PC 12 displays the generated barcode 64A on the screen of the LCD 64 (step S23).

Next, the setting PC 12 determines whether to end the display of the barcode 64A (step S24). The setting PC 12 determines to end the display of the barcode 64A in response to, for example, the user having performed an instruction to end the display, a predetermined time having elapsed since the display, or the like. If the display of the barcode 64A is not ended (No in step S24), the processing returns to step S24 and the display of the barcode 64A is continued.

On the other hand, in a case where the display of the barcode 64A is ended (Yes in step S24), the setting PC 12 ends the display of the barcode 64A and the processing returns to step S21. That is, a processing for generating and displaying another barcode is started.

As described above, the setting PC 12 can display the barcode 64A encoded with the input information, based on the operation by the user.

[Barcode Control Processing by Mobile PC 16]

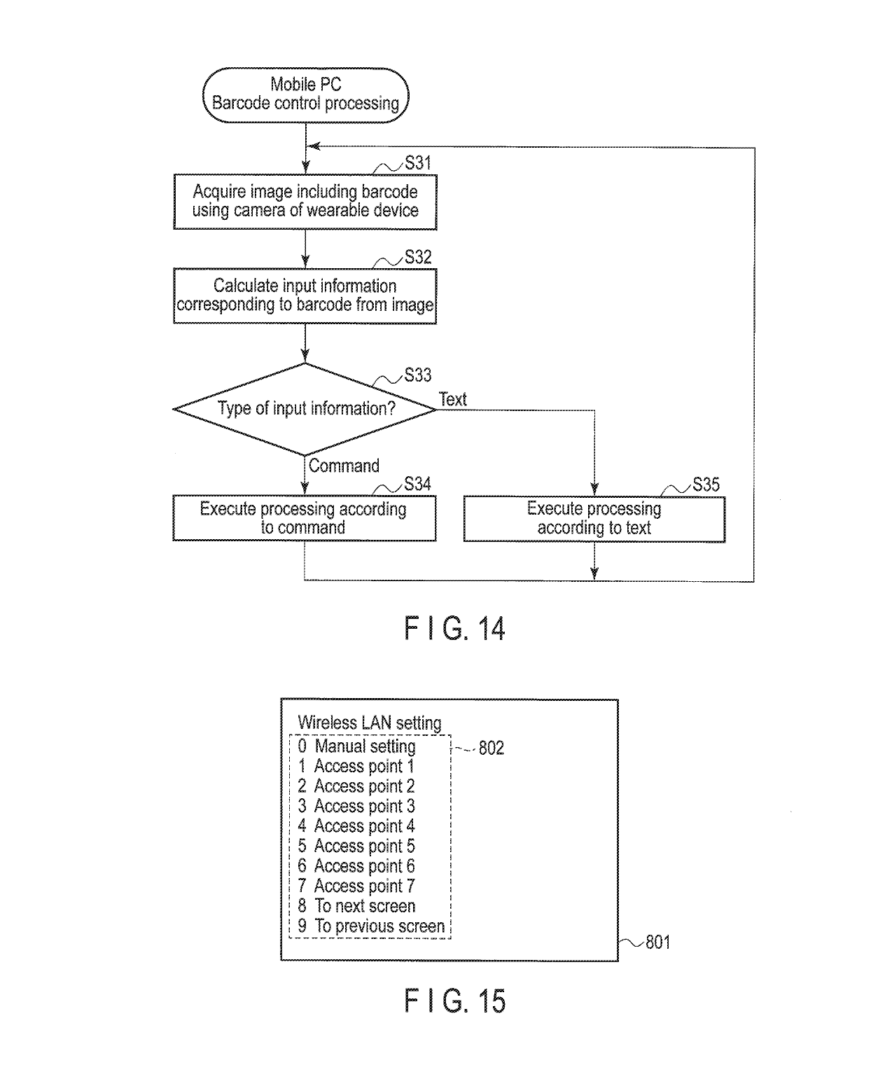

An example of the procedure of the barcode control processing executed by the mobile PC 16 will be described with reference to the flowchart in FIG. 14. Here, it is assumed that the barcode 64A is displayed on the screen of the setting PC 12.

First, the mobile PC 16 acquires an image including the barcode 64A using the camera 116 of the wearable device 23 (step S31). Then, the mobile PC 16 calculates the input information corresponding to the barcode 64A from the acquired image (step S32).

Next, the mobile PC 16 identifies the type of the calculated input information (step S33). In a case where the type of the input information is a command (command of step S33), the mobile PC 16 executes processing according to the command included in the input information (step S34) and the processing returns to step S31. On the other hand, in a case where the type of the input information is a text (text of step S33), the mobile PC 16 executes processing according to the text included in the input information (step S35) and the processing returns to step S31.

As described above, the mobile PC 16 can read the barcode 64A displayed on the screen of the setting PC 12 and execute processing corresponding to the barcode 64A. Therefore, the user can cause the mobile PC 16 to execute any processing without any manual operation on the mobile PC 16.

[Example of Wireless LAN Access Point Setting Using Barcode]

As an example of control of the mobile PC 16 using the barcode 64A, processing for setting a new wireless LAN access point in the mobile PC 16 will be described below.

(1) The setting PC 12 displays, on the screen of the LCD 64, a first barcode encoded with the input information for activating the program for setting a wireless LAN access point, based on the operation by the user. The input information includes, for example, an ID (for example, “0001”) for identifying that the input information is a command and a command for activating the program for setting the wireless LAN access point (for example, start command specifying a program name).

(2) The mobile PC 16 acquires an image in which the first barcode is captured with the camera 116 of the wearable device 23, and interprets the first barcode in the image. That is, the mobile PC 16 calculates, from the image, input information with which the first barcode is encoded.

(3) The mobile PC 16 activates the program for setting the wireless LAN access point by executing the command indicated in the calculated input information. Then, the mobile PC 16 displays a wireless LAN access point setting screen 801 as shown in FIG. 15 on the screen of the display 124 of the wearable device 23.

As shown in FIG. 15, the wireless LAN access point setting screen 801 includes multiple items 802 for setting the wireless LAN access point. The items 802 are selected according to the input of the corresponding number. More specifically, these items 802 indicate as follows.

The input of “0” corresponds to the manual setting,
the inputs of “1” to “7” correspond to the setting to respective seven access points among the large number of access points included in the list of available surrounding access points,
the input of “8” corresponds to the display of the next page of the list of the available access points, and
the input of “9” corresponds to the display of the previous page of the list of the available access points.

(4) The setting PC 12 displays, on the screen of the LCD 64, a second barcode encoded with input information of any one of “0” to “9”, based on the operation of the user inputting any one of “0” to “9”. The input information includes, for example, an ID (for example, “0002”) for identifying that the input information is a text and a numeral (text) indicating any one of “0” to “9”. Hereinafter, it is assumed that “0” is input by user operation.

(5) The mobile PC 16 acquires an image in which the second barcode is captured with the camera 116 of the wearable device 23, and interprets the second barcode in the image. That is, the mobile PC 16 calculates, from the image, input information with which the second barcode is encoded.

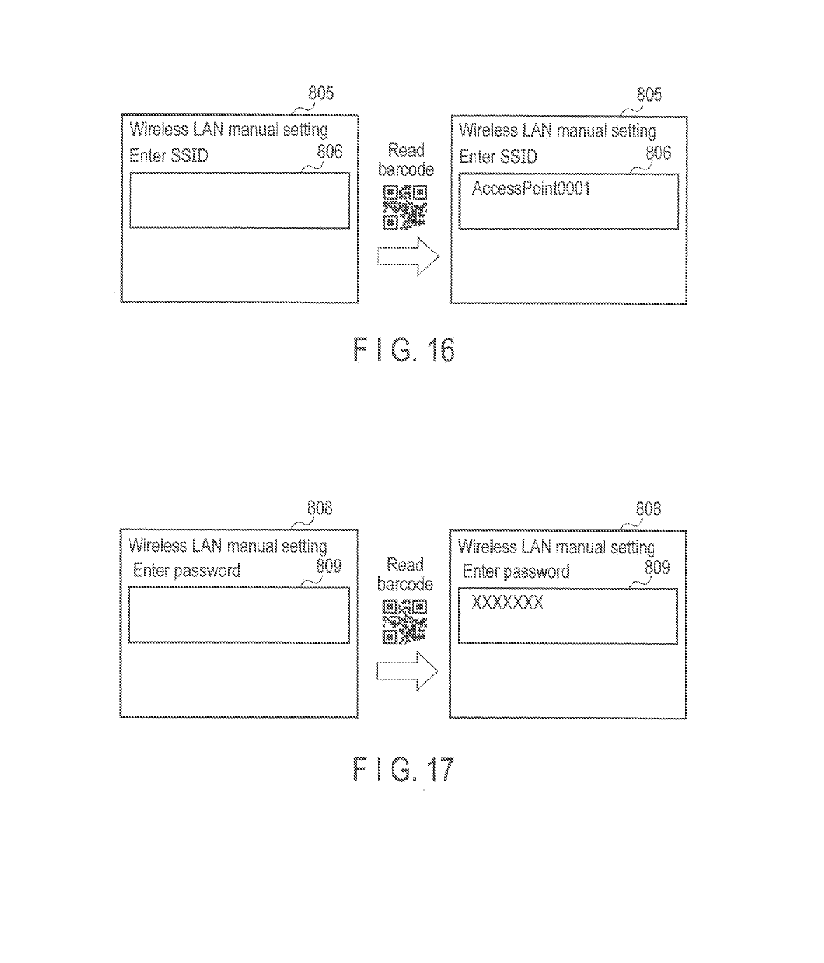

(6) The mobile PC 16 activates a program for manual setting of the wireless LAN access point by inputting “0”, which is the text indicated in the calculated input information. Then, the mobile PC 16 displays an SSID manual setting screen 805 as shown in FIG. 16 on the screen of the display 124 of the wearable device 23. The SSID manual setting screen 805 includes a text area 806 for inputting the SSID of the manually set access point.

(7) The setting PC 12 displays, on the screen of the LCD 64, a third barcode encoded with input information of the SSID, based on the operation of the user inputting the SSID. The input information includes, for example, an ID (for example, “0002”) for identifying that the input information is a text and a text indicating the SSID.

(8) The mobile PC 16 acquires an image in which the third barcode is captured with the camera 116 of the wearable device 23, and interprets the third barcode in the image. That is, the mobile PC 16 calculates, from the image, input information with which the third barcode is encoded.

(9) As shown in FIG. 16, the mobile PC 16 sets the SSID by inputting “AccessPoint0001”, which is the text indicated in the calculated input information, into the text area 806. Then, in response to the setting of the SSID, the mobile PC 16 causes the display 124 of the wearable device 23 to display a password input screen 808 as shown in FIG. 17. The password input screen 808 includes a text area 809 for inputting the password of the manually set access point.

(10) The setting PC 12 displays, on the screen of the LCD 64, a fourth barcode encoded with input information of the password, based on the operation of the user inputting the password. The input information includes, for example, an ID (for example, “0002”) for identifying that the input information is a text and a text indicating the password.

(11) The mobile PC 16 acquires an image in which the fourth barcode is captured with the camera 116 of the wearable device 23, and interprets the fourth barcode in the image. That is, the mobile PC 16 calculates, from the image, input information with which the fourth barcode is encoded.

(12) As shown in FIG. 17, “XXXXXXX”, which is the text indicated in the calculated input information, is input in the text area 809, so that the mobile PC 16, in communication with the access point designated by the SSID, executes authentication processing based on the inputted password. When the authentication is successful, the setting of the access point is completed in the mobile PC 16, and communication via the access point is enabled.

In this way, by reading the barcode corresponding to the command and the barcode corresponding to the text, the mobile PC 16 can execute any processing.

Note that as in the case where an operation for inputting text is performed after the operation for executing the command, when a series of operations is performed on the mobile PC 16, the setting PC 12 can generate the barcode encoded with input information indicating a series of macro-operations. For example, the setting PC 12 encodes one barcode with input information indicating a series of operations in which the above program for setting the wireless LAN access point is activated, “0” corresponding to the manual setting is input, the SSID is input, and the password is input. As a result, the mobile PC 16 can complete the manual setting of the wireless LAN access point merely by reading the barcode. Further, the setting is not limited to the setting of the wireless LAN access point. Application of various settings such as the initial setting of the mobile PC 16 can facilitate setting and control of the mobile PC 16 by using the barcode.

### Second Embodiment

In the first embodiment, the barcode encoded with the input information is displayed on the screen of the setting PC 12. In contrast, in a second embodiment, a secret key for generating a one-time password is shared between a setting PC 12 and a mobile PC 16, and the barcode encoded with the input information and the one-time password is displayed on the screen of the setting PC 12.

The configurations of an electronic apparatus (mobile PC 16), a wearable device 23, and a setting PC 12 according to the second embodiment are the same as those of the electronic apparatus (mobile PC 16), the wearable device 23, and the setting PC 12 of the first embodiment respectively. Only the procedure of the processing corresponding to a generator 502 of the setting PC 12 and the procedure of the processing corresponding to an execution controller 603 of the mobile PC 16 are different between the second embodiment and the first embodiment. Only differences from the first embodiment will be described below.

[Control Sequence]

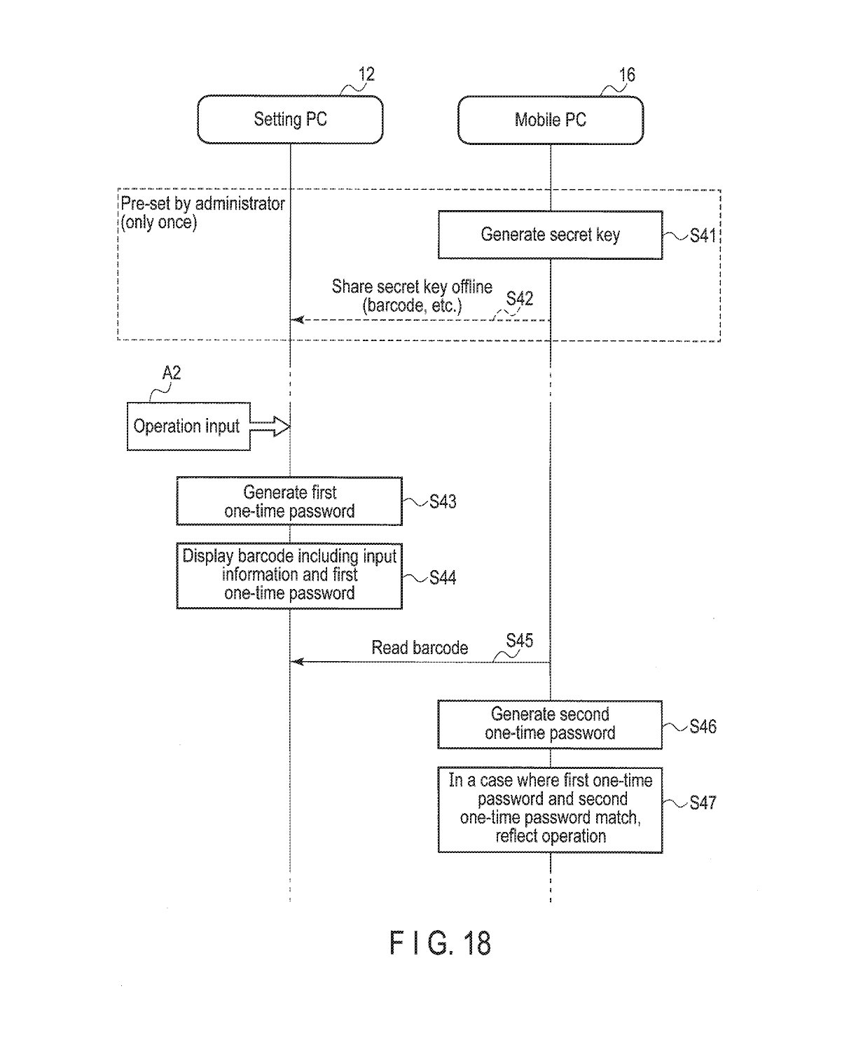

FIG. 18 shows an example of a control sequence executed in the control system 1 of this embodiment. In this control sequence, the control of the mobile PC 16 using the barcode is protected (secured).

First, the mobile PC 16 generates a secret key for generating a one-time password (S41). The secret key is generated only once, for example, in response to a prior manipulation by the administrator. The one-time password generated using the secret key is, for example, an HMAC-based One-Time Password (HOTP), a Time-based One-Time Password (TOTP), or the like. The mobile PC 16 stores the generated secret key into a storage device 330 in the mobile PC 16.

Next, the mobile PC 16 shares the secret key offline with the setting PC 12 (S42). For example, the mobile PC 16 displays a barcode encoded with a secret key on a screen of a display connected to the mobile PC 16, and causes the camera (connected to the setting PC 12) to read the displayed barcode, thereby causing a storage device 52 in the setting PC 12 to store the barcode. The display connected to the mobile PC 16 is, for example, a display connected via a display terminal (not shown) such as an HDMI terminal. Further, the camera connected to the setting PC 12 is, for example, a camera (not shown) connected via a USB connector 72 or a camera (not shown) built in the setting PC 12.

Alternatively, the mobile PC 16 stores secret key data into a portable storage medium such as a USB flash memory, and the storage medium is connected to the USB connector 72 or the like of the setting PC 12. The mobile PC 16 causes the storage device 52 in the setting PC 12 to store the secret key data into the storage medium. As a result, the secret key is shared between the mobile PC 16 and the setting PC 12.

The setting PC 12 may generate the secret key. In this case, the setting PC 12 can share the secret key offline with the mobile PC 16 in the same way as the above method.

In a state in which the secret key is shared, in response to the artificial operation input A2 by the user, the setting PC 12 uses the secret key stored in the setting PC 12 to generate a first one-time password (S43). In the operation input A2, the user inputs input information for controlling the mobile PC 16 using various input devices for inputting operations by the user. The setting PC 12 displays, on the screen, a barcode 64A based on the input information by the operation input A2 and the generated first one-time password (S44).

Next, the mobile PC 16 reads the barcode 64A displayed on the screen of the setting PC 12 using a camera 116 of the wearable device 23 (S45). In reading the barcode 64A, the mobile PC 16 interprets the barcode 64A to acquire the input information and the first one-time password with which the barcode 64A is encoded.

Next, the mobile PC 16 generates a second one-time password using the secret key stored in the mobile PC 16 (S46). Then, in a case where the first one-time password matches the second one-time password, the mobile PC 16 reflects the operation corresponding to the barcode 64A that has been read (S47). That is, the mobile PC 16 executes the processing corresponding to the input information with which the barcode 64A is encoded.

As a result, the operation input A2 on the setting PC 12 can be reflected as an operation input on the mobile PC 16. Furthermore, the one-time password based on the secret key shared between the setting PC 12 and the mobile PC 16 is used, so that it is possible to control the mobile PC 16 only with the barcode generated by the setting PC 12 having the secret key. Therefore, it is possible to prevent the mobile PC 16 from being controlled by an unintended barcode (for example, a barcode displayed on a screen of another PC, a barcode on a printed matter, or the like) by a third party.

[Functional Configuration of Setting PC 12]

The functions of the user interface 501 and the display controller 503 are described above with reference to FIG. 10. The storage 504 further stores a secret key 504B shared with the mobile PC 16.

The generator 502 generates a first one-time password using the secret key 504B. Then, the generator 502 generates a barcode 64A that is encoded with the input information (generated by the user interface 501) and the first one-time password. The generated barcode 64A is displayed on the screen of the LCD 64 by the display controller 503.

[Functional Configuration of Mobile PC 16]

The functions of the image receiver 601 and the calculator 602 are described above with reference to FIG. 12. The image receiver 601 acquires an image in which the barcode 64A is captured, and the calculator 602 calculates information with which the barcode 64A is encoded from this image. The calculated information includes the input information and the first one-time password. The storage 604 further stores the secret key 504B shared with the setting PC 12.

The execution controller 603 generates a second one-time password using the secret key 504B. In a case where the first one-time password matches the second password, the execution controller 603 causes the mobile PC 16 to execute processing according to the input information.

[Barcode Generation Processing by Setting PC 12]

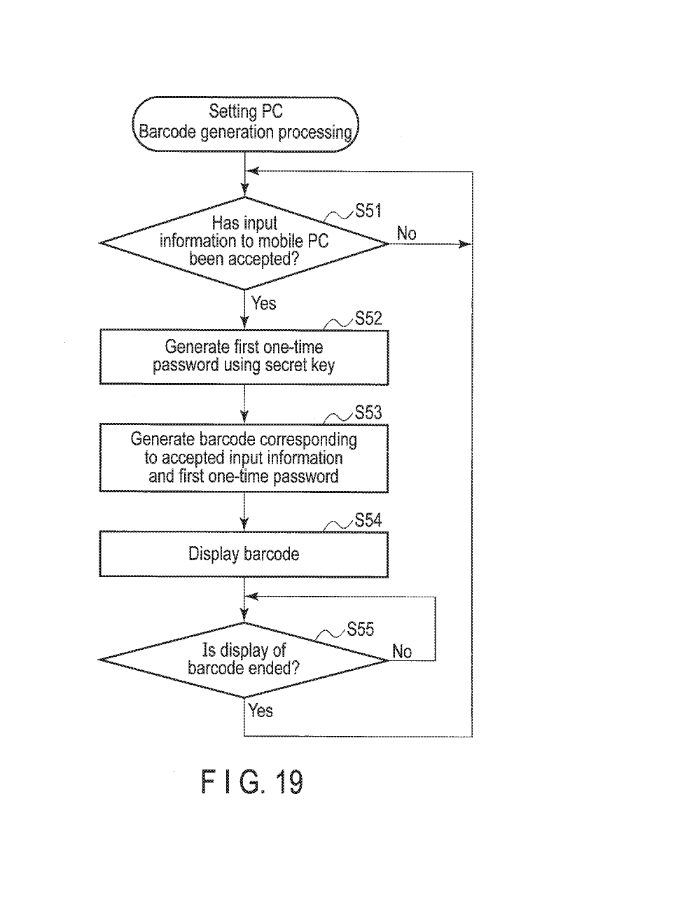

An example of the procedure of the barcode generation processing executed by the setting PC 12 will be described with reference to the flowchart in FIG. 19.

First, the setting PC 12 determines whether input information to the mobile PC 16 has been accepted (step S51). The setting PC 12 can accept information for controlling the mobile PC 16. The information is inputted using a keyboard 88, a touch panel 70, or the like. In a case where the setting PC 12 has not accepted input information to the mobile PC 16 yet (No in step S51), the processing returns to step S51 and again it is determined whether input information to the mobile PC 16 has been accepted.

In a case where the setting PC 12 has accepted the input information to the mobile PC 16 (Yes in step S51), the setting PC 12 generates the first one-time password using the secret key 504B shared with the mobile PC 16 (step S52). The setting PC 12 generates the barcode 64A corresponding to the accepted input information and the first one-time password (step S53). The generated barcode 64A is a barcode encoded with the input information and the first one-time password. Then, the setting PC 12 displays the generated barcode 64A on the screen of the LCD 64 (step S54).

Next, the setting PC 12 determines whether to end the display of the barcode 64A (step S55). The setting PC 12 determines to end the display of the barcode 64A in response to, for example, the user's instruction to end the display, a predetermined time having elapsed since the display, or the like. In a case where the display is not ended (No in step S55), the processing returns to step S55 and the display of the barcode 64A is continued.

On the other hand, in a case where the display is ended (Yes in step S55), the setting PC 12 ends the display of the barcode 64A and the processing returns to step S51. That is, processing for generating and displaying another barcode is started.

As described above, the setting PC 12 can display the barcode 64A encoded with the input information (based on the operation by the user) and the first one-time password (generated using the shared secret key 504B).

[Barcode Control Processing by Mobile PC 16]

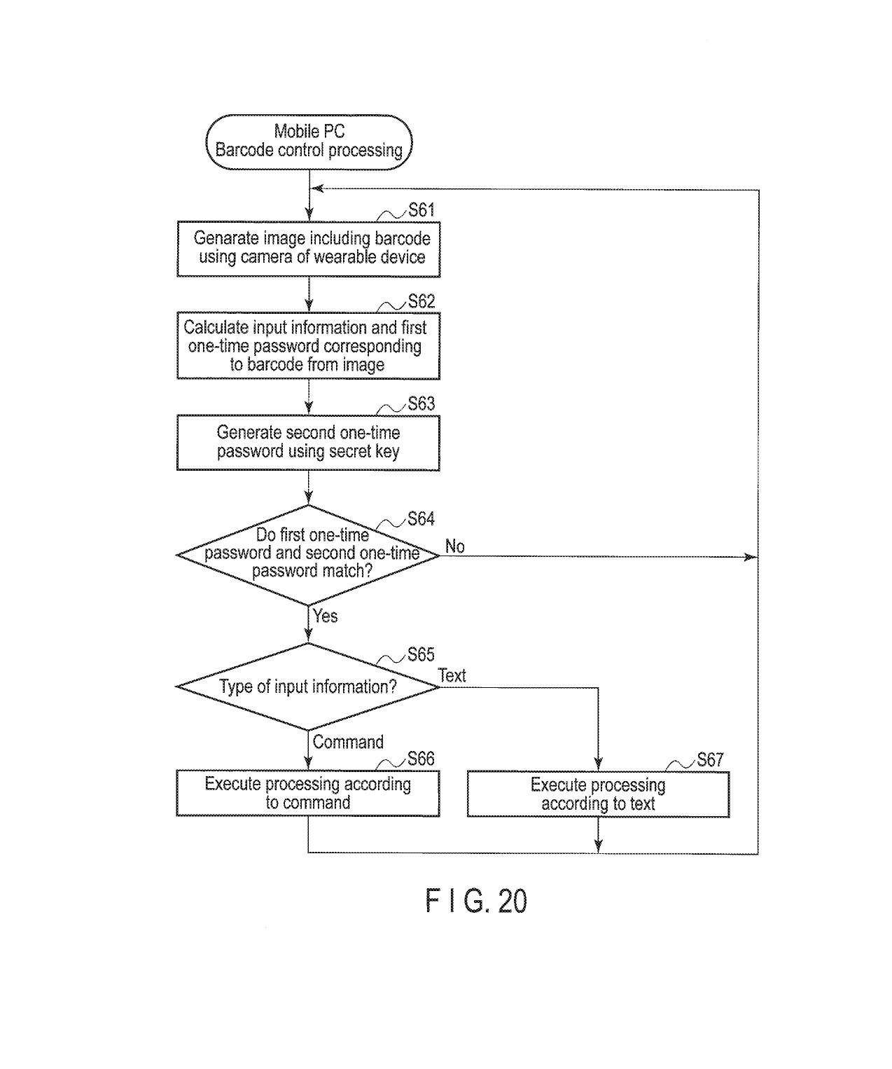

An example of the procedure of the barcode control processing executed by the mobile PC 16 will be described with reference to the flowchart in FIG. 20. Here, it is assumed that the barcode 64A is displayed on the screen of the setting PC 12.

First, the mobile PC 16 generates an image including the displayed barcode 64A using the camera 116 of the wearable device 23 (step S61). Then, the mobile PC 16 calculates input information and the first one-time password corresponding to the barcode 64A from the acquired image (step S62).

Next, the mobile PC 16 generates the second one-time password using the secret key 504B shared with the setting PC 12 (S63). The mobile PC 16 determines whether the first one-time password matches the second one-time password (step S64). In a case where the first one-time password is generated using the secret key 504B shared between the mobile PC 16 and the setting PC 12, the first one-time password matches the second one-time password.

In a case where the first one-time password does not match the second one-time password (No in step S64), the mobile PC 16 determines that the barcode 64A is an unintended barcode and the processing returns to step S61.

In a case where the first one-time password matches the second one-time password (Yes in step S64), the mobile PC 16 identifies the type of the calculated input information (step S65). In a case where the type of the input information is a command (command of step S65), the mobile PC 16 executes processing according to the command included in the input information (step S66) and the processing returns to step S61. In a case where the type of the input information is a text (text of step S65), the mobile PC 16 executes processing according to the text included in the input information (step S67) and the processing returns to step S61.

As described above, the mobile PC 16 reads the barcode 64A displayed on the screen of the setting PC 12. In a case where the first one-time password obtained by interpreting the barcode 64A matches the second one-time password generated by the mobile PC 16, the mobile PC 16 determines that the processing is intended, and can execute processing corresponding to the barcode 64A. Therefore, the user can cause the mobile PC 16 to execute any processing only with the barcode generated by the setting PC 12 having the secret key 504B without any manual operation on the mobile PC 16.

As described above, according to the first and second embodiments, it is possible to easily control the electronic apparatus without hindering the operation. For devices, controllers, connectors, and the like for wired or wireless communication, the mobile PC 16 is connected in a wired or wireless manner to the wearable device 23 which can be worn by the user. In a case where the barcode 64A encoded with the information is displayed on the screen of the LCD 64 provided in the setting PC 12, the image receiver 601 acquires the image in which the barcodes 64A is captured using the camera 116 provided in the wearable device 23. The calculator 602 calculates information from the barcode 64A in the image. The execution controller 603 causes the mobile PC 16 to execute processing corresponding to the calculated information.

As a result, the user does not connects input devices such as a keyboard, a touch panel, or a mouse to the mobile PC 16, and, without directly operating such input devices, the user can easily control the mobile PC 16 merely by directing the camera 116 of the wearable device 23 connected to the mobile PC 16, to the barcode 64A. Therefore, the user carrying the mobile PC 16, wearing the wearable device 23 and performing a hands-free operation, can easily operate the mobile PC 16, even if no input device such as a mouse or a keyboard is connected to the mobile PC 16.

In addition, each of the various functions described in some embodiments may be implemented by a circuit (processing circuit). Examples of processing circuits include programmed processors such as a central processing unit (CPU). This processor executes each of the described functions by executing computer programs (instructions) stored in the memory. The processor may be a microprocessor including an electrical circuit. Examples of processing circuits include a digital signal processor (DSP), an application specific integrated circuit (ASIC), a microcontroller, a controller, and other electrical circuit components. Each of the components other than the CPU described in these embodiments may also be implemented by the processing circuit.

In addition, since the various processing according to some embodiments can be realized by a computer program, merely by installing this computer program in a computer through a computer readable storage medium in which this computer program is stored to execute the installed program, it is possible to easily realize the same effect as those of these embodiments.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus carried by a user, the electronic apparatus comprising:
a transceiver that establishes a wired connection or a wireless connection between the electronic apparatus and a wearable device that is worn by the user; and
a hardware processor that
acquires an image depicting a barcode encoded with information using a camera provided in the wearable device when the barcode is displayed on a screen of an external electronic device,
determines the information encoded in the barcode from the image of the barcode, and
executes processing, based on the information determined from the barcode.

2. The electronic apparatus of claim 1, wherein
the information comprises at least one of a command executed by the electronic apparatus and a text input to the electronic apparatus.

3. The electronic apparatus of claim 2, wherein
the information further comprises information indicative of a type of input information to the electronic apparatus.

4. The electronic apparatus of claim 1, wherein
the information and a first one-time password are encoded in the barcode, and
the hardware processor further
determines the information and the first one-time password encoded in the barcode from the image of the barcode,
generates a second one-time password, and
executes the processing when the first one-time password matches the second one-time password.

5. The electronic apparatus of claim 4, wherein
the hardware processor further generates the second one-time password using a secret key shared between the electronic apparatus and the external electronic apparatus, and
the first one-time password matches the second one-time password when the first one-time password is generated using the secret key.

6. The electronic apparatus of claim 4, wherein
each of the first one-time password and the second one-time password is either an HMAC-based One-Time Password (HOTP) or a Time-based One-Time Password (TOTP).

7. A control method of an electronic apparatus that is carried by a user, the control method comprising:
establishing a wired connection or a wireless connection between the electronic apparatus and a wearable device that is worn by the user;
acquiring an image depicting a barcode encoded with information using a camera provided in the wearable device when the barcode is displayed on a screen of an external electronic device;
determining the information encoded in the barcode from the image of the barcode; and
causing the electronic apparatus to execute processing, based on the information determined from the barcode.

8. The control method of claim 7, wherein
the information comprises at least one of a command executed by the electronic apparatus and a text input to the electronic apparatus.

9. The control method of claim 7, wherein
the information and a first one-time password are encoded in the barcode, and
the control method further comprises
determining the information and the first one-time password encoded in the barcode from the image of the barcode,
generating a second one-time password, and
causing the electronic apparatus to execute the processing when the first one-time password matches the second one-time password.

10. The control method of claim 9, further comprising:
generating the second one-time password using a secret key shared between the electronic apparatus and the external electronic apparatus,
wherein the first one-time password matches the second one-time password when the first one-time password is generated using the secret key.

11. A computer-readable, non-transitory storage medium storing a computer program which is executable by a computer carried by a user, the computer program controlling the computer to execute functions of:
establishing a wired connection or a wireless connection between the computer and a wearable device that is worn by the user;
acquiring an image depicting a barcode encoded with information using a camera provided in the wearable device when the barcode is displayed on a screen of an external electronic device;
determining the information encoded in the barcode from the image of the barcode; and
executing processing, based on the information determined from the barcode.

12. The storage medium of claim 11, wherein
the information comprises at least one of a command executed by the computer and a text input to the computer.

13. The storage medium of claim 11, wherein
the information and a first one-time password are encoded in the barcode, and
the computer program controls the computer to further execute functions of:
determining the information and the first one-time password encoded in the barcode from the image of the barcode;
generating a second one-time password; and
executing the processing when the first one-time password matches the second one-time password.

14. The storage medium of claim 2, wherein
the computer program controls the computer to further execute a function of generating the second one-time password using a secret key shared between the computer and the external electronic apparatus, and
the first one-time password matches the second one-time password when the first one-time password is generated using the secret key.

15. A control system comprising a first electronic apparatus, a second electronic apparatus that is carried by a user, and a wearable device that is worn by the user, wherein
the first electronic apparatus
generates a barcode encoded with information, based on an artificial operation, and
displays the barcode on a screen, and the second electronic apparatus
establishes a wired connection or a wireless connection between the second electronic apparatus and the wearable device,
acquires an image depicting the barcode using a camera provided in the wearable device,
determines the information encoded in the barcode from the image of the barcode, and
executes processing, based on the information determined from the barcode.

16. The control system of claim 15, wherein
the information comprises at least one of a command executed by the second electronic apparatus and a text input to the second electronic apparatus.

17. The control system of claim 15, wherein
the information and a first one-time password are encoded in the barcode, and
the second electronic apparatus further
determines the information and the first one-time password encoded in the barcode from the image of the barcode,
generates a second one-time password, and
executes the processing the first one-time password matches the second one-time password.

18. The control system of claim 17, wherein
the second electronic apparatus further generates the second one-time password using a secret key shared between the second electronic apparatus and the first electronic apparatus, and
the first one-time password matches the second one-time password when the first one-time password is generated using the secret key.
